(19) United States
(12) Patent Application Publication
(10) Pub. No.: US 2023/0110505 A1
(43) Pub. Date: Apr. 13, 2023

(54) METHODS AND APPARATUS OF RELIABLE MULTICAST TRANSMISSION

(71) Applicant: MediaTek Singapore Pte. Ltd., Singapore (SG)

(72) Inventor: Xuelong Wang, Beijing (CN)

(21) Appl. No.: 18/057,194

(22) Filed: Nov. 18, 2022

Related U.S. Application Data
(63) Continuation of application No. PCT/CN2021/096456, filed on May 27, 2021.
Application No. PCT/CN2021/096456 is a continuation of application No. PCT/CN2020/092682, filed on May 27, 2020.
Application No. PCT/CN2020/092682 is a continuation-in-part of application No. PCT/CN2020/009662, filed on May 27, 2020.

(30) Foreign Application Priority Data
May 27, 2020 (CN) PCT/CN2020/092682
May 27, 2021 (CN) PCT/CN2021/096456

(51) Int. Cl. H04W 36/00; H04L 1/1812; H04L 1/08; H04W 76/30

(52) U.S. Cl. CPC H04W 36/0007; H04L 1/1812; H04L 1/08; H04W 76/30

(57) ABSTRACT

Apparatus and methods are provided for reliable multicast transmission. In one novel aspect, a new multicast radio bearer structure with associated unicast RB is provided to enable reliable multicast transmission. In one embodiment, the associated unicast RB is used for both the uplink feedback and downlink retransmission of the multicast packets. In another embodiment, dynamic transmission mode switch procedure is provided. The MBS transmission switches from PTM transmission to PTP transmission. The MBS packets reception at the UE switches from the PTM leg to the PTP leg. In one embodiment, the dynamic switch procedure is anchored by the common PDCP entity of the PTM leg and the PTP leg. In another embodiment, lossless handover is achieved via PDCP layer packets-based data forwarding for the multicast transmission. In one embodiment, a counter or a timer is used to control the number of packets being forwarded to the target.

### CROSS REFERENCE TO RELATED APPLICATIONS

This application is filed under 35 U.S.C. § 111(a) and is based on and hereby claims priority under 35 U.S.C. § 120 and § 365(c) from International Application No. PCT/CN2021/096456, titled “METHODS AND APPARATUS OF RELIABLE MULTICAST TRANSMISSION,” with an international filing date of May 27, 2021. International Application PCT/CN2021/096456, in turn, claims priority under 35 U.S.C. § 120 and § 365(c) from International Application No. PCT/CN2020/092682, titled “Methods of RLC based Reliable Multicast Transmission,” with an international filing date of May 27, 2020, and International Application No. PCT/CN2020/09662 titled “Methods and apparatus of Methods of PDCP based Reliable Multicast Transmission,” with an international filing date of May 27, 2020. The disclosure of each of the foregoing documents is incorporated herein by reference.

### TECHNICAL FIELD

The disclosed embodiments relate generally to wireless communication, and, more particularly, to reliable multicast transmission.

### BACKGROUND

With the exponential growth of wireless data services, the content delivery to large mobile user groups has grown rapidly. Initial wireless multicast/broadcast services include streaming services such as mobile TV and IPTV. With the growing demand for large group content delivery, recent application development for mobile multicast services requires highly robust and critical communication services such as group communication in disaster situations and the necessity of public safety network-related multicast services. The early 3GPP in the LTE standard defines enhanced multimedia broadcast multicast services eMBMS. The single-cell point to multipoint (SC-PTM) services and multicast-broadcast single-frequency network (MBSFN) is defined. The fifth generation (5G) multicast and broadcast services (MBS) are defined based on the unicast 5G core (5GC) architecture. Reliability transmission for the multicast services in the NR system needs to be addressed. In particular, the retransmission of the multicast packets is needed to provide reliable services.

Improvements and enhancements are required to support reliable multicast transmission and reception in the NR network.

### SUMMARY

Apparatus and methods are provided for reliable multicast transmission. In one novel aspect, a new multicast radio bearer structure with associated unicast RB is provided to enable reliable multicast transmission. In one embodiment, the associated unicast RB is used for both the uplink feedback and downlink retransmission of the multicast packets. In another embodiment, dynamic transmission mode switch procedure is provided. The MBS transmission switches from PTM transmission to PTP transmission. The MBS packets reception at the UE switches from the PTM leg to the PTP leg. In one embodiment, the PTM leg and the PTP leg are configured with a common PDCP entity and two different RLC entities including a PTM RLC entity for the PTM leg and a PTP RLC entity for the PTP leg. The dynamic switch is triggered by one or more triggering event including, L1 HARQ, L2 RLC status report or L2 PDCP status report. The dynamic switch procedure is anchored by the common PDCP entity of the PTM leg and the PTP leg. In another embodiment, lossless handover is achieved via PDCP layer packets-based data forwarding during the mobility for the multicast transmission for the UE. The UE performs the handover from a source node to a target node, associates the PTP leg with a unicast RB of the target node and unacknowledged PDCP packets through PTP leg, wherein the PDCP packets were transmitted from a PTP leg of the source node and was forwarded by the source node to the target node. In one embodiment, a counter or a timer is used to control the amount of packets being forwarded to the target to avoid redundant packet forwarding.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic system diagram illustrating an exemplary NR wireless network that supports reliable multicast transmission for multicast services in a NR network in accordance with embodiments of the current invention.

FIG. 2 illustrates an exemplary NR wireless system with centralized upper layers of the NR radio interface stacks and UE stack with multicast protocol and unicast protocol in accordance with embodiments of the current invention.

FIG. 3 illustrates exemplary diagrams of different procedures for reliable MBS transmission and reception based on different UE feedback for broadcast RB using an associated PTP leg in accordance with embodiments of the current invention.

FIG. 4 illustrates exemplary diagrams for multicast RB reception structure with the PTP leg configured associated with the PTM leg to enable reliable MBS in accordance with embodiments of the current invention.

FIG. 5 illustrates exemplary diagrams for the dynamic transmission mode switch procedure with the multicast RB removed after the switch in accordance with embodiments of the current invention.

FIG. 6 illustrates exemplary diagrams for the dynamic transmission mode switch procedure with the multicast RB kept after the switch in accordance with embodiments of the current invention.

FIG. 7 illustrates exemplary diagrams for reliable MBS procedures during the handover process to reduce handover interruptions in accordance with embodiments of the current invention.

FIG. 8 illustrates an exemplary flow chart for the reliable MBS procedure in accordance with embodiments of the current invention.

### DETAILED DESCRIPTION

Reference will now be made in detail to some embodiments of the invention, examples of which are illustrated in the accompanying drawings.

Aspects of the present disclosure provide methods, apparatus, processing systems, and computer readable mediums for NR (new radio access technology, or 5G technology) or other radio access technology. NR may support various wireless communication services, such as enhanced mobile broadband targeting wide bandwidth, millimeter wave targeting high carrier frequency, massive machine type communications targeting non-backward compatible MTC techniques, and/or mission critical targeting ultra-reliable low-latency communications. These services may include latency and reliability requirements. These services may also have different transmission time intervals (TTI) to meet respective quality of service (QoS) requirements. In addition, these services may co-exist in the same subframe.

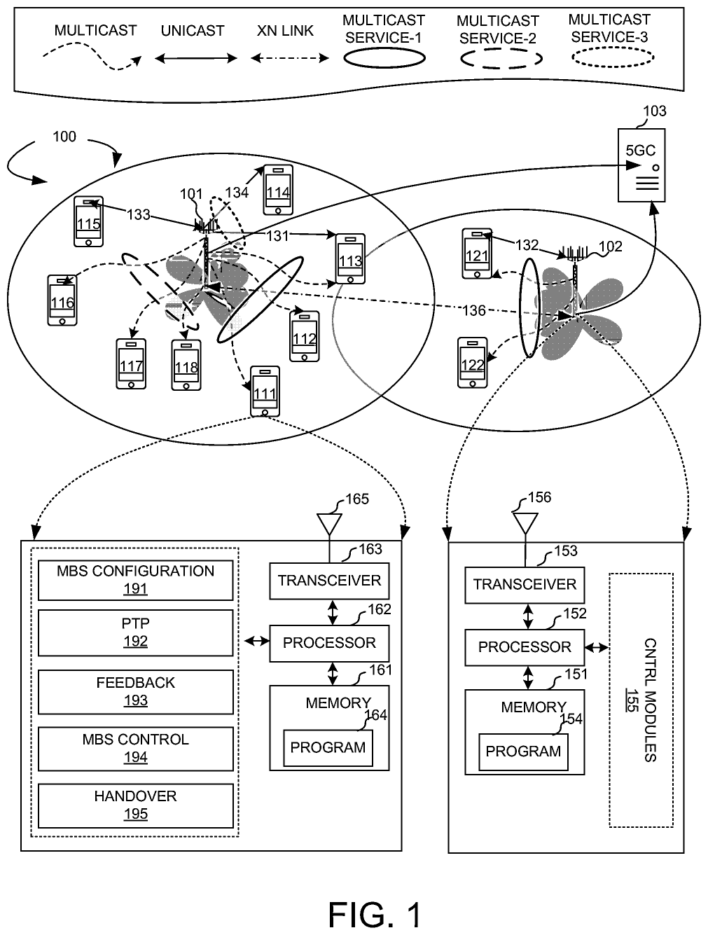

FIG. 1 is a schematic system diagram illustrating an exemplary NR wireless network that supports reliable multicast transmission for multicast services in a NR network in accordance with embodiments of the current invention. NR wireless system 100 includes one or more fixed base infrastructure units forming a network distributed over a geographical region. The base unit may also be referred to as an access point, an access terminal, a base station, a Node-B, an eNode-B (eNB), a gNB, or by other terminology used in the art. The network can be homogeneous network or heterogeneous network, which can be deployed with the same frequency or different frequency. gNB 101 and gNB 102 are base stations in the NR network, the serving area of which may or may not overlap with each other. The backhaul connection such as 136, connects the non-co-located receiving base units, such as gNB 101 and gNB 102. These backhaul connections, such as connection 136, can be either ideal or non-ideal. gNB 101 connects with gNB 102 via Xnr interface. The base stations, such as gNB 101 and gNB 102, connects to the 5G core (5GC) network 103 through network interfaces, such as N2 interface for the control plane and N3 interface for the user plane.

NR wireless network 100 also includes multiple communication devices or mobile stations, such user equipments (UEs) such as UEs 111, 112, 113, 114, 116, 117, 118, 121 and 122. The mobile devices can establish one or more unicast connections with one or more base stations. For example, UE 115 has unicast connection 133 with gNB 101. Similarly, UEs 121 connects with gNB 102 with unicast connection 132.

In one novel aspect, one or more radio bearers are established for one or more multicast sessions/services. In particular, a point-to-multipoint (PTM) leg is established between the UE and the gNB for MBS. A point-to-point (PTP) leg associated with the PTM leg is established for reliable transmission and reception in corresponding gNB and UE protocol stacks. A multicast service-1 is provided by gNB 101 and gNB 102. UEs 111, 112 and 113 receive multicast services from gNB 101. UEs 121 and 122 receive multicast services from gNB 102. Multicast service-2 is provided by gNB 101 to the UE group of UEs 116, 117, and 118. Multicast service-1 and multicast service-2 are delivered in multicast mode with a multicast radio bearer (MRB) configured by the NR wireless network. The receiving UEs receives data packets of the multicast service through corresponding MRB configured. UE 111 receives multicast service-1 from gNB 101. gNB 102 provides multicast service-1 as well. In one novel aspect, a unicast RB associated with the multicast RB is configured for reliable MBS. UE 121 is configured with multicast service-1. UE 121 is configured multicast RB with a PTM leg as well as the unicast RB 132, with a PTP leg. The associated PTP 132 is used to provide reliable MBS for UE 121. Similarly, for UEs 111, 112, and 113, which receive multicast service-1 through corresponding multicast RB/PTM protocol stack leg, each UE is also configured with a corresponding associated PTP leg, not shown, for reliability. Similarly, for multicast service-2, UEs 116, 117, and 118 which receive multicast service-1 through corresponding multicast RB/PTM protocol stack leg, each UE is also configured with a corresponding associated PTP leg, not shown, for reliability. In one scenario, multicast services are configured with unicast radio bearers. A multicast service-3 is delivered to UE 113 and UE 114 via unicast radio link 131 and 134, respectively. In one embodiment, the MBS delivered through unicast bearer through PTP protocol stack are switched to PTM leg configured for the UE upon detecting predefined events. The gNB, upon detecting one or more triggering event, switches service mode from unicast to multicast using PTM legs.

FIG. 1 further illustrates simplified block diagrams of a base station and a mobile device/UE for multicast transmission. gNB 102 has an antenna 156, which transmits and receives radio signals. An RF transceiver circuit 153, coupled with the antenna, receives RF signals from antenna 156, converts them to baseband signals, and sends them to processor 152. RF transceiver 153 also converts received baseband signals from processor 152, converts them to RF signals, and sends out to antenna 156. Processor 152 processes the received baseband signals and invokes different functional modules to perform features in gNB 102. Memory 151 stores program instructions and data 154 to control the operations of gNB 102. gNB 102 also includes a set of control modules 155 that carry out functional tasks to communicate with mobile stations.

FIG. 1 also includes simplified block diagrams of a UE, such as UE 111. The UE has an antenna 165, which transmits and receives radio signals. An RF transceiver circuit 163, coupled with the antenna, receives RF signals from antenna 165, converts them to baseband signals, and sends them to processor 162. In one embodiment, the RF transceiver may comprise two RF modules (not shown). A first RF module is used for HF transmitting and receiving, and the other RF module is used for different frequency bands transmitting and receiving which is different from the HF transceiver. RF transceiver 163 also converts received baseband signals from processor 162, converts them to RF signals, and sends out to antenna 165. Processor 162 processes the received baseband signals and invokes different functional modules to perform features in UE 111. Memory 161 stores program instructions and data 164 to control the operations of UE 111. Antenna 165 sends uplink transmission and receives downlink transmissions to/from antenna 156 of gNB 102.

The UE also includes a set of control modules that carry out functional tasks. These control modules can be implemented by circuits, software, firmware, or a combination of them. A MBS configuration module 191 configures an MBS in the wireless network with a point-to-multipoint (PTM) leg in a protocol stack of the UE. A PTP module 192 configures PTP leg in the protocol stack of the UE, wherein the PTP leg is associated with the PTM leg for the MBS. A feedback module 193 transmits feedbacks for the MBS reception, wherein the feedback is performed with at least one process selecting from a layer-1 (L1) hybrid automatic repeat request (HARQ), a layer-2 (L2) radio link control (RLC) feedback, and a L2 packet data convergence protocol (PDCP) feedback. An MBS control module 194 performs a reliable MBS procedure based on the feedbacks, wherein the reliable MBS procedure is one selecting from a dynamic transmission mode switch procedure between the PTM leg and the PTP leg, and a PTP retransmission assistant procedure. A handover module 195 performs handover from a source node to a target node, associates the PTP leg with a unicast RB of the target node, and receives unacknowledged PDCP packets through PTP leg, wherein the PDCP packets were transmitted from a PTP leg of the source node and was forwarded by the source node to the target node.

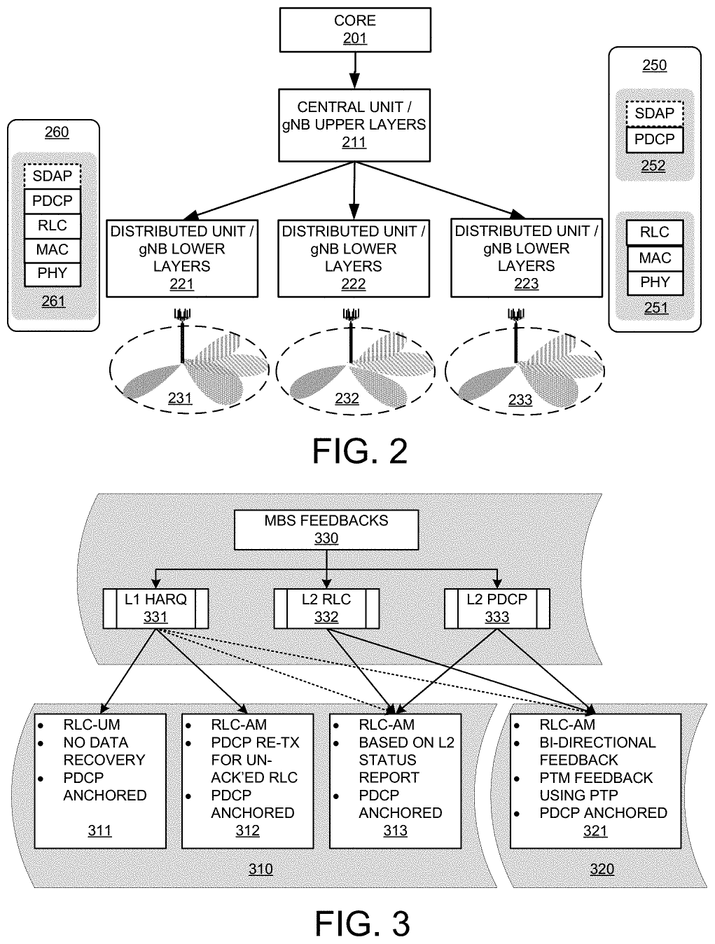

FIG. 2 illustrates an exemplary NR wireless system with centralized upper layers of the NR radio interface stacks and UE stack with multicast protocol and unicast protocol in accordance with embodiments of the current invention. Different protocol split options between central unit (CU) and distributed unit (DU) of gNB nodes may be possible. The functional split between the CU and DU of gNB nodes may depend on the transport layer. Low performance transport between the CU and DU of gNB nodes can enable the higher protocol layers of the NR radio stacks to be supported in the CU, since the higher protocol layers have lower performance requirements on the transport layer in terms of bandwidth, delay, synchronization, and jitter. In one embodiment, SDAP and PDCP layer are located in the CU, while RLC, MAC and PHY layers are located in the DU. A core unit 201 is connected with one central unit 211 with gNB upper layer 252. In one embodiment 250, gNB upper layer 252 includes the PDCP layer and optionally the SDAP layer. Central unit 211 connects with distributed units 221, 222, and 221. Distributed units 221, 222, and 223 each corresponds to a cell 231, 232, and 233, respectively. The DUs, such as 221, 222 and 223 includes gNB lower layers 251. In one embodiment, gNB lower layers 251 include the PHY, MAC and the RLC layers. In another embodiment 260, each gNB has the protocol stacks 261 including SDAP, PDCP, RLC, MAC and PHY layers.

In certain systems, such as NR systems, NR multicast/broadcast is transmitted in the coverage of a cell. From logical channel perspective, multicast control channel (MCCH) provides the information of a list of NR multicast/broadcast services with ongoing sessions transmitted on multicast traffic channel(s) (MTCH). At the physical layer, MTCH is scheduled by gNB in the common search space (CSS) of PDCCH with group radio network temporary identifier (G-RNTI) scrambled. The UE decodes the MTCH data for a multicast session in the multicast physical downlink shared channel (PDSCH). When the multimedia broadcast and multicast services (MBMS) or enhanced MBMS (eMBMS) are unidirectional transmissions, RLC unacknowledged mode (UM) is used to multicast broadcast sessions. For NR MBS, reliable transmission is required. Due to the characteristics of MBS, it is hard for the network to ensure all UEs receiving the MBS transmission successful without severely impacting the radio resource utilization efficiency. In one novel aspect, an uplink feedback channel is used for reliable MBS. A PTP leg is configured to be associated with the PTM leg for the multicast RB. The PTP leg enables a dynamic switch to the unicast mode for the MBS or provide unicast retransmission for the unsuccessful packets at the PTM leg.

FIG. 3 illustrates exemplary diagrams of different procedures for reliable MBS transmission and reception based on different UE feedback for broadcast RB using an associated PTP leg in accordance with embodiments of the current invention. The uplink feedback 330 includes layer-1 (L1) hybrid automatic repeat request (HARQ) 331, a layer-2 (L2) radio link control (RLC) feedback 332, and a L2 packet data convergence protocol (PDCP) feedback 333. When only L1 feedback is supported, the feedback channel is a unidirectional channel from the UE to the network. When L2 feedback is supported, the feedback channel can be a bidirectional channel between the UE and the network, with the assumption that the network may take that channel to perform needed packet retransmission at L2. In practice, the packet retransmission can be L1 HARQ retransmission, L2 RLC retransmission, L2 PDCP retransmission or any form of the combination among them.

In one embodiment, the UE performs a reliable MBS procedure 310 based on the feedbacks using dynamic transmission mode switch procedure between the PTM leg and the PTP leg configured for the UE. In another embodiment, the UE performs a reliable MBS procedure 310 based on the feedbacks using a PTP retransmission assistant procedure 320. Dynamic transmission mode switch procedure includes three scenarios 311, 312, and 313. For procedure 311, the packet retransmission only happens at L1 HARQ based on L1 HARQ feedback. For normal data transfer, the reliability is handled by L1 for multicast services. The switching is expected to perform from PTM to PTP (i.e. unicast) for multicast transmission if the link quality is lower than a predefined first threshold. When the link quality is higher than a predefined second threshold, the switching can be performed from PTP (i.e. unicast) to PTM for multicast transmission. In one embodiment, the first threshold and the second threshold are the same. In another embodiment, the first threshold and the second threshold are different. The RLC mode of PTP leg is configured as same as PTM leg, i.e., with RLC-UM. In one embodiment, the dynamic switch mode procedure is selected based on the type of the MBS. In one embodiment, procedure 311 is applicable to the multicast services that has lower QoS requirement. In one embodiment, the QoS requirement for an MBS are predefined or preconfigured. Each MBS is predefined or preconfigured with a QoS requirement. Procedure 311 assumes L1 HARQ feedbacks from the receiving UEs to the network. Based on the feedback, the network triggers PTM/PTP switch at PDCP layer (i.e., PDCP anchored PTM/PTP switch). There is no data recovery during the switching procedure. In this case, the reliability is ensured by L1 HARQ.

In another embodiment, the UE uses procedure 312 for reliable MBS. The packet retransmission can only take at L1 HARQ, which is the same as procedure 311. The RLC mode of the PTM leg in the protocol stack is configured as RLC-UM, while the RLC mode of PTP in the protocol stack is configured as RLC acknowledged mode (AM). In one embodiment, procedure 312 is applicable to the multicast services that require slightly high QoS based transmission. Similar to procedure 311, the network enables PTM/PTP switch at PDCP layer (i.e., PDCP anchored PTM/PTP switch) based on statistics of the HARQ feedback from all UEs receiving the MBS. Data recovery is needed during the switch. One transmission block as transmitted by HARQ is MAC PDU, which is assembled based on RLC packets and/or RLC segments. In one embodiment, the network buffers the PDCP packets if the corresponding RLC packets and/or RLC segments were not successfully transmitted. During PTM/PTP switch, these PDCP packets are retransmitted to the UE via the PTP leg based on the L2 feedback (i.e. RLC status report or PDCP status report). At the UE side upon receiving the packets, the packet handling is in the PDCP, which enables reordering, duplicate handling, etc. The UE can support the triggering of status report based on the need to support PTP leg in RLC AM. The status report (i.e., RLC status report or PDCP status report) may reflect the reception status of the data packets received from PTM leg and/or PTP leg.

In yet another embodiment, the UE uses procedure 313 for reliable MBS. The packet retransmission can take at both L1 HARQ and L2 PDCP. The RLC mode of PTM leg of the protocol stack is configured as RLC-UM. The RLC mode of PTP leg of the protocol stack is configured as RLC AM. In procedure 313, the UE provides L2 (RLC and/or PDCP) status report to the network. A bidirectional L2 feedback channel is configured. The network switches the PTM transmission to PTP transmission when the status report from a particular UE reflects bad reception quality. The PDCP anchored PTM/PTP switch is also supported at this case.

In one embodiment, the UE performs reliable MBS using a PTP retransmission assistant procedure 320. A bidirectional feedback channel is created in unicast manner per UE. The benefit to establish separate unicast channels for the UEs is that when there is a need for performing retransmission for multicast packets, the packets can be delivered over the unicast channel specific to the UE. In this manner, the downlink multicast transmission is not delayed or stalled by the potential retransmission required by a limited number of UEs. The UE's PDCP feedback on the reception of the PTM transmission at PDCP layer can be sent over the unicast feedback channel to the network. The network retransmits the PDCP packets via either the PTM leg or PTP leg according to the reception of the PDCP feedback from multiple UEs. In case there is a need to perform retransmission to a specific UE, the network triggers the UE to switch from the PTM leg to the PTP leg. In another embodiment, in procedure 321, the network uses the specific PTP leg of the UE to assist the required retransmission. The UE transmits feedbacks for the MBS received on the PTM leg through a unicast RB using the PTP leg and receives retransmission of MBS packets through the unicast RB using the PTP leg. In one embodiment, the PTP leg is configured to be associated with the PTM leg only to assist the retransmission for the MBS. The PTM PDCP packets continues even though there is a need to perform PDCP retransmission on a particular PTP leg towards a particular UE. In one embodiment, a threshold is configured on the maximum PDCP retransmission that can be performed at the unicast channel with the PTP leg for the multicast transmission. If the UE reaches the maximum PDCP retransmission, UE can be switched from PTM leg to PTP leg.

The retransmission is triggered at the PDCP layer for the unsuccessfully transmitted packets for a particular UE. The PTM leg can take retransmission if multiple UEs do not successfully receive the multicast packets. Otherwise, the associated unicast RB is used by the gNB/base station to perform the downlink retransmission for unacknowledged PTM packets according to the uplink PDCP reception status report from each UE. In one embodiment, the gNB/base station uses the associated unicast channel to poll the particular UE to report its reception status of the PDCP packets received from the air interface for the NR multicast/broadcast service(s). In another embodiment, the base station/gNB uses the PTM leg to poll all receiving UEs to report the reception status. In another embodiment, the associated unicast RB supports uplink RLC feedback, i.e., the UE reports RLC status, the reception status of the RLC packets received from the associated unicast RB(s). The PTM radio bearer, the PTM RB, the PTM leg are used interchangeably. The multicast radio bearer, multicast RB, and MRB are used interchangeably. Unicast radio bearer, unicast RB, and PTP RB, PTP leg are used interchangeably.

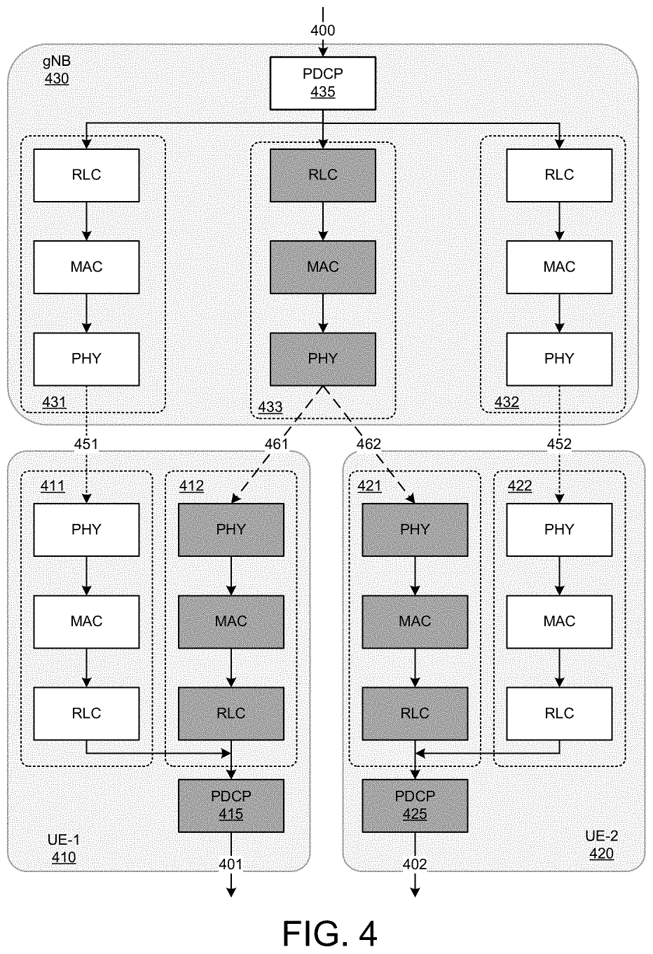

FIG. 4 illustrates exemplary diagrams for multicast RB reception structure with the PTP leg configured associated with the PTM leg to enable reliable MBS in accordance with embodiments of the current invention. gNB 430 receives MBS 400 for transmission to UE-1 410 and UE-2 420. gNB 430 is configured with one PDCP entity 435 for the PTM leg 433, PTP leg 431 serving UE-1 410, and PTP leg 432 serving UE-2 420. The gNB PTM leg 433 transmits to UE-1 and UE-2 through broadcast RB 461 and 462, scrambled with the G-RNTI for the MBS. PTP leg 431 transmits to UE-1 410 through unicast RB 451 scrambled with C-RNTI of UE-1 410. PTP leg 432 transmits to UE-2 420 through unicast RB 452 scrambled with C-RNTI of UE-2 420. Each UE, such as UE-1 410 and UE-2 420, participating the reception of the MBS service monitors the PDCCH via both G-RNTI corresponding to the NR multicast/broadcast service and UE specific C-RNTI. Both new data coming from PTM RB and the retransmitted data coming from the associated unicast/PTP RB will be combined at the PDCP entity at each UE, UE-1 410 and UE-2 420. From UE perspective, for a particular MRB, there exists two legs, one is PTM RB and the other is PTP RB, i.e., the associated unicast RB. Each UE is configured a common PDCP entity for the PTM leg and associated PTP leg. UE-1 410 is configured with common PDCP entity 415 common to the UE PTP leg 411 and UE PTM leg 412. UE-2 420 is configured with common PDCP entity 425 common to the UE PTP leg 421 and UE PTM leg 422. The transmission model for reliable multicast transmission is similar to an intra-UE dual connection (DC) operation. The reliable MBS transmission and reception with the PTM leg and associated PTP leg is anchored on the PDCP layer. The PDCP entity within each UE is responsible to reorder the packets coming from different legs, to detect and discard the duplicates, before delivering to higher layer. there is only a single PDCP entity established for the multicast RB, shared by both PTM RB and PTP RB. The PDCP entity is responsible for the sequence number allocation, security handling and robust header compression (ROHC) for the PDCP service data units (SDU). In case of multicast and unicast co-existence, the configuration of security handling and ROHC for PDCP SDU subject to p-t-m transmission and p-t-p transmission should be aligned. The UE common PDCP entity passes the received PDCP packets, such as UE-1 reception 410 and UE-2 reception 420, to corresponding upper layers of the UE.

In one embodiment, there is a direct interaction between the common PDCP entity of the multicast RB and the RLC entities of PTM RB and the PTP RB. The PDCP entity of the multicast RB needs to send the PDCP packets with PDCP SN to the RLC entity of the PTM and/or PTP RB to allow it to perform packets transmission at RLC layer. The said PDCP packets can be ciphered or non-ciphered. The said PDCP packets can be compressed or non-compressed. Upon detecting one or more predefined switching conditions, the network switches to use unicast transmission to transmit the multicast flow to the UE to improve the resource utilization efficiency. When there is a need to switch the multicast/broadcast transmission to unicast transmission for the NR multicast/broadcast service, the PDCP entity 435 of multicast flow(s) at the network disables the PTM RB and its corresponding RLC entity 433. Then the PDCP entity 435 of the network established specific to the NR multicast/broadcast service delivers the new data packets coming from the multicast flow(s) to each RLC entity, such as RLC entity of 431 for UE-1 410 and RLC entity 432 for UE-2 420, established for associated unicast RB (i.e. PTP RB). The associated unicast RB transits to a regular unicast RB. When there are multiple UEs, the PDCP entity 435 at the gNB are shared among the UEs from downlink transmission perspective for the multicast flow(s). Service continuity is expected during dynamic transmission mode switch procedure for reliable MBS.

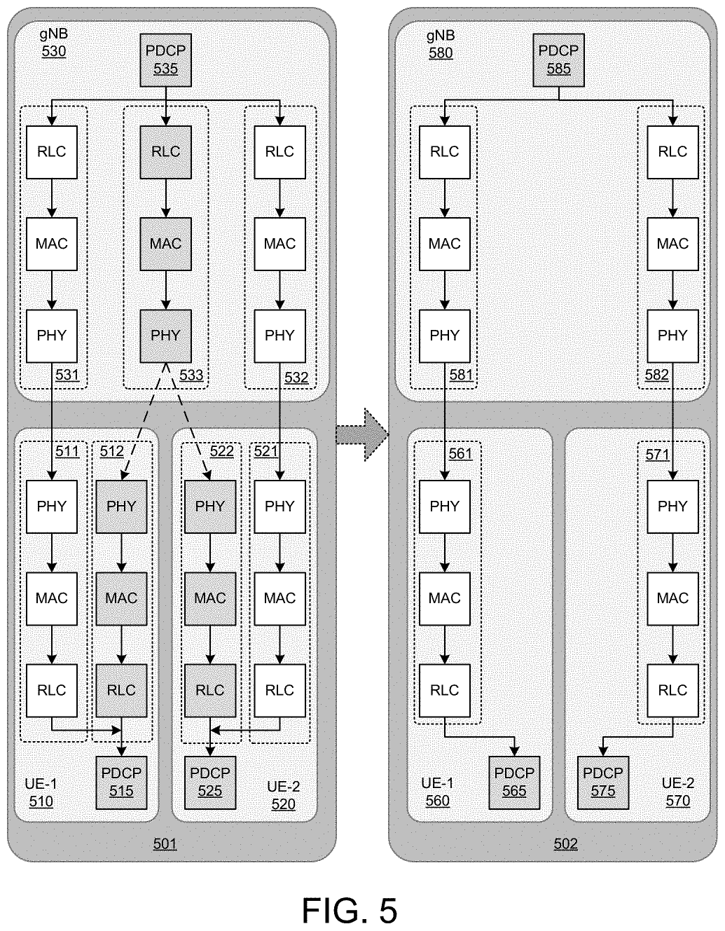

FIG. 5 illustrates exemplary diagrams for the dynamic transmission mode switch procedure with the multicast RB removed after the switch in accordance with embodiments of the current invention. In one embodiment, after the dynamic transmission mode switch, the PTM RB is removed after the MBS switches from multicast to unicast. The UE does not need to monitor the PTM RB. The network needs to notify the PTM-to-PTP switch to the UE to perform such adaption from UE side. The notification can be sent from the network to the UE in any form of RRC message, MAC CE, or L1 DCI.

The before-switch exemplary network diagram 501 includes a before-switch gNB 530, UE-1 510, and UE-2 520. The gNB 530 transmits MBS packets to UE-1 510 and UE-2 520. gNB 530 is configured with one PDCP entity 535 for the PTM leg 533, PTP leg 531 serving UE-1 510, and PTP leg 532 serving UE-2 520. The gNB PTM leg 533 transmits to UE-1 and UE-2 through broadcast RB scrambled with the G-RNTI for the MBS. PTP leg 531 transmits to UE-1 510 through unicast RB scrambled with C-RNTI of UE-1 510. PTP leg 532 transmits to UE-2 520 through unicast RB scrambled with C-RNTI of UE-2 520. The network performs a multicast to unicast switch procedure upon detecting one or more predefined conditions. The after-switch system diagram 502 includes configurations for gNB 580, UE-1 560, and UE-2 570. The configuration The UEs (both UE1 and UE2) inherit the same PDCP entity after the switch from multicast to unicast. The after-switch PDCP entities 585, 565, and 574 inherit the same PDCP entity of 535, 515, and 525, respectively. After the switch from multicast to unicast, the associated unicast RB is transited into a regular unicast RB to support the data transmission for the multicast session in point-to-point (i.e., PTP) manner. The after-switch PTP leg 581 and 582 transmits the MBS packets to UE-1 and UE-2 with unicast RB. The after-switch UE-1 560 has PTP leg includes 561 and PDCP 565. The after-switch UE-2 570 has PTP leg includes 571 and PDCP 575. Specific to the switch from multicast to unicast, some PDCP packets for the multicast RB can be transmitted after switch by the unicast RB to the UE. The exact PDCP packets that is subject to network retransmission depends on the UE's PDCP or RLC status report. In another embodiment, the PDCP entity of the previous multicast RB is released, a new PDCP entity is established for each PTP RB and the SDAP entity of the corresponding multicast session can interact with the new PDCP entity of the regular unicast RB established for each UE. It is applicable to both UE side and network side. PDCP 535, 515 and 525 are released after the switch. New PDCP entities 585, 565, and 575 are established for the PTP RB. In this manner, multicast transmission to the UEs can support asynchronous transmission.

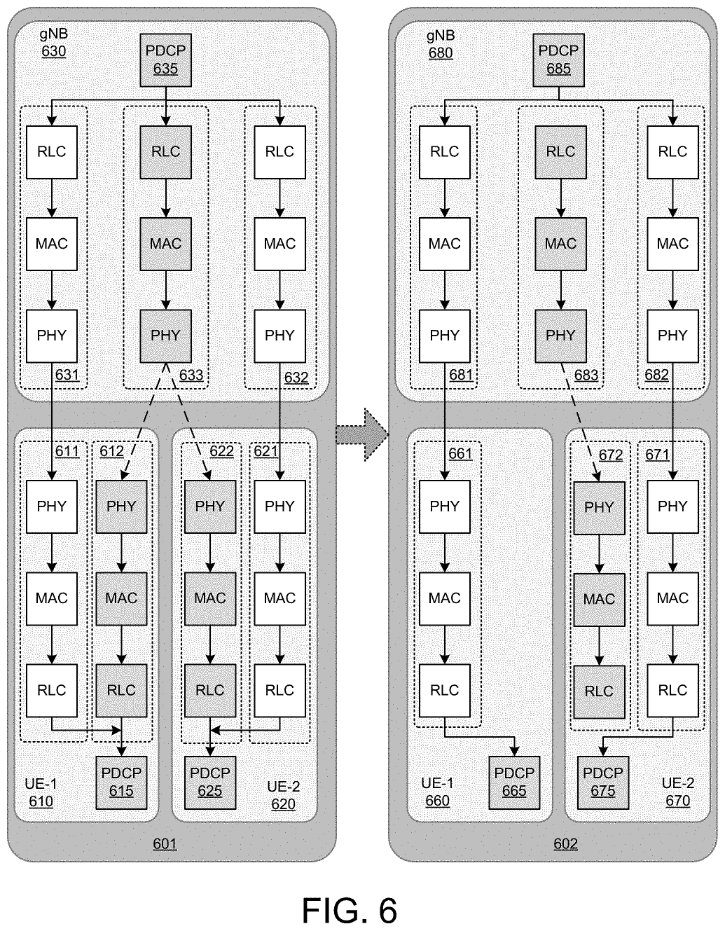

FIG. 6 illustrates exemplary diagrams for the dynamic transmission mode switch procedure with the multicast RB kept after the switch in accordance with embodiments of the current invention. In one embodiment, the PTM RB is kept after the switch from PTM to PTP. The before-switch exemplary network diagram 601 includes a before-switch gNB 630, UE-1 610, and UE-2 620. The gNB 630 transmits MBS packets to UE-1 610 and UE-2 620. gNB 630 is configured with one PDCP entity 535 for the PTM leg 633, PTP leg 631 serving UE-1 610, and PTP leg 632 serving UE-2 620. The gNB PTM leg 633 transmits to UE-1 and UE-2 through broadcast RB scrambled with the G-RNTI for the MBS. PTP leg 631 transmits to UE-1 610 through unicast RB scrambled with C-RNTI of UE-1 610. PTP leg 632 transmits to UE-2 620 through unicast RB scrambled with C-RNTI of UE-2 620. The network performs a multicast to unicast switch procedure upon detecting one or more predefined conditions. The after-switch system diagram 602 includes configurations for gNB 680, UE-1 660, and UE-2 670. When there is a need to switch the PTM transmission to PTP transmission for the NR multicast/broadcast service for UE1, the PDCP entity 685 of available multicast RB at the network needs to start to send the data to the PTP RLC entity 661 of UE-1. The unicast RB of UE-1 is transited into a regular unicast RB for reliable multicast transmission. In another embodiment the UE can also be switched from PTP to PTM transmission. Assuming the PTM RB was established for other UEs before the PTP to PTM switch for a particular UE. The network can notify this particular UE to monitor G-RNTI for multicast reception after that switch. From UE reception perspective, UE-2 670 can use the PDCP entity 671 established for PTP reception to receive the PTM RB. If there is no existing PTM leg for the multicast RB before the switch, the network needs to establish a new PTM RB 683 to enable the PTM transmission for the UE. This new PTM RB 683 can inherit the same PDCP entity as PTP leg(s) for the multicast RB. The PDCP entity 685 in the network side needs to deliver the new data packets to the PTM RLC entity 672 to enable p-t-m based transmission. PTP to PTM switch, from UE perspective, the monitoring on the PDCCH scheduling the PTM RB is needed after the switch. The network needs to notify this switch to the UE to perform such monitoring from UE side. Specific to the switch from unicast to multicast, the undelivered or unacknowledged packets of the PDCP entity of the regular unicast RB for the UE can be transmitted by the associated unicast RB, with PTP leg, such as 631 and 632, to the UE after the regular unicast RB is transited into an associated unicast RB. After the transmission mode switch from unicast to multicast, or from multicast to unicast, the associated unicast RB or regular unicast RB can be subject to RRC reconfiguration. During the dynamic transmission mode switch, the SDAP configuration is seen unchanged as there is no change for multicast session. During the reconfiguration, the same PDCP configuration is applied.

In other embodiments, reliable MBS procedures reduce handover interruptions. The UE(s) with reception of the MBS may be subject to movements. Regular interruptions for the reception of these MBS cannot meet the QoS requirement of the MBS that is expected to take reliable transmission. There are various scenarios for service continuity specific to the UE receiving the Multicast/Broadcast services. When the target cell does not support or start the multicast transmission for the MBS, switching the UE from the source cell to the target cell may enable the target cell to transmit the MBS to the UE in unicast manner. Otherwise, the UE can join the available MBS in the target cell and continue its reception of that service in multicast manner.

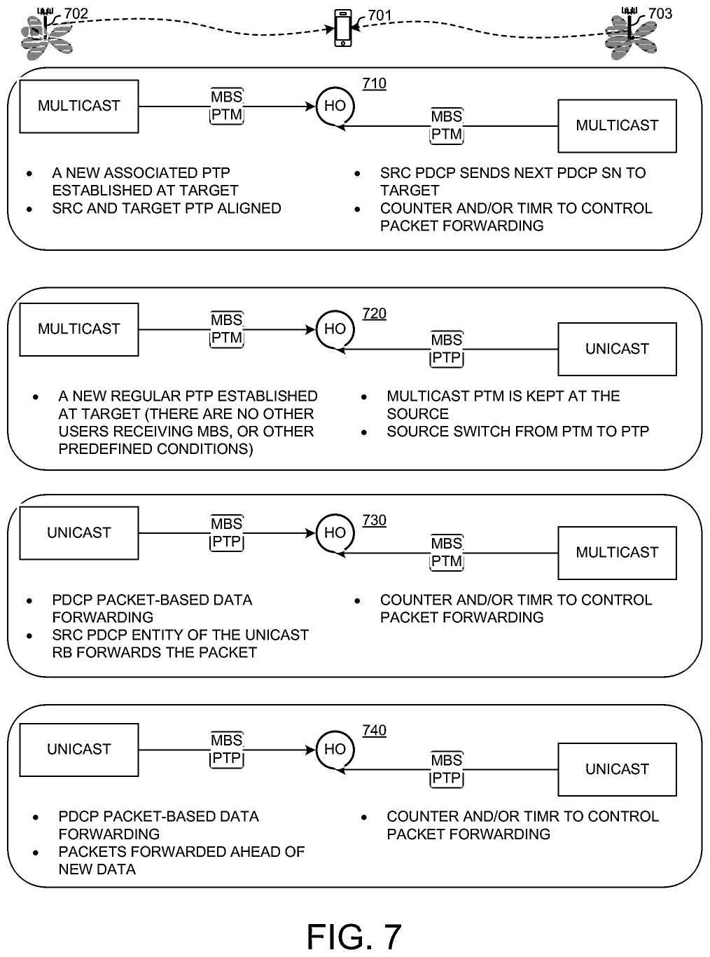

FIG. 7 illustrates exemplary diagrams for reliable MBS procedures during the handover process to reduce handover interruptions in accordance with embodiments of the current invention. The UE 701 receives MBS from a source cell 702. UE 701 performs a handover during the MBS and connects with a target cell 703. There are different scenarios including multicast to multicast handover 710, multicast to unicast handover 720, unicast to unicast handover 730, and unicast to unicast 740.

During multicast-to-multicast switch procedure 710, the multicast transmission for the NR MBS is already available in the target cell 703. The PTM radio bearer with multicast PDCP entity is already established at target cell 703 running in the target node. In a regular handover procedure, there would be a gap between the reception of the multicast transmission from the source cell 702 and the reception of the multicast transmission from the target cell 703. The UE may miss some of the packets of multicast session during that gap when performing handover. In order to remove the possibility of packet loss during the gap for cell switch for UE 701, the undelivered or non-acknowledged packets are forwarded from source node 702 to the target node 703. In one embodiment, the same PDCP sequence number (SN) numbering is supported between source node and target node. The characteristic of the forwarded packets is subject to the radio bearer structure adopted for multicast mobility. The associated unicast RB is available at source node for the UE to support reliable multicast/broadcast transmission. The PDCP entity of the multicast RB always sends the copy of the PDCP packets to the PDCP entity within this unicast RB for the UE. The PDCP entity buffers the PDCP packets. During multicast-to-multicast handover, a new associated unicast RB is established at target node for the UE. The PDCP entity buffering the PDCP packets from source side needs to forward the unacknowledged and/or undelivered PDCP packets to the associated unicast PDCP entity in the target node. The configuration of the PDCP entities for associated unicast RB between source node and target node should be aligned.

In one embodiment, the PDCP entity from source side 702 sends the downlink transmission status including the next PDCP SN to be used to the target node 703. In this manner, the consistent and contiguous allocation of PDCP SN can be performed on the coming data flow from upper layer. In another embodiment, some packets are forwarded to target and be transmitted to the UE via unicast manner. However, the same data may be transmitted to the UE via multicast radio bearer at the target node. This case will occur if the handover procedure is performed very quickly, and the UE immediately joins the multicast reception in the target cell. Both the source node 702 and target node 703 receives MBS packets from network entity user plane function (UPF). In one embodiment, the source node 702 determines the number of packets are subject to forwarding. Forwarding too many packets to target node will lead to redundant reception at UE side. Forwarding too few packets to target node will lead to reception interruption for the service at UE side. It may be a trade-off between service continuity and resource utilization efficiency. In one embodiment, a forwarding counter is used to control the amount of PDCP packets, which are subject to data forwarding. In another embodiment, a timer is used to serve the same purpose. The precise selection of the counter or timer ensures needed service continuity and avoid redundant packet forwarding.

During the multicast to unicast procedure 720, the target node 703 needs to establish a new regular unicast radio bearer to transmit the multicast data to the concerned UE. This scenario may be enabled when there is no other UE in the target cell participating the reception of the multicast/broadcast service or other preconfigured triggering conditions. In this scenario, the multicast session is kept at the source node 702 after UE switch. However, it is also possible that after the handover, the source node switch its p-t-m transmission to p-t-p transmission for the UEs serving by source node if there are only limited number of UEs after the handover.

During the multicast-to-unicast procedure 730, the associated unicast RB is available at source node for the UE to support reliable multicast/broadcast transmission. The same PDCP packets-based data forwarding is performed as the case of multicast-to-multicast handover 710. The only difference is that the recipient of the PDCP packets is the PDCP entity of the new regular unicast radio bearer established at the target node for the UE. In one embodiment, these packets can be transmitted to the UE ahead of any new data coming from the PDCP entity established common to the multicast flow(s). For multicast-to-unicast handover, the PDCP entity established for multicast session is not released. In this way, the network can speed up the addition of new unicast RB for newly joining UE. As an alternative for multicast→unicast handover, the PDCP entity established for multicast session can be released. The SDAP entity of the multicast session at the target node interacts directly with PDCP entity of the regular unicast RB established at the target node. In case there is no other UE in the cell joining the reception of the multicast/broadcast transmission, new multicast RB needs to be established at target node. In this case, the source cell indicates the next PDCP SN to the target cell to allow the PDCP entity of the target node to make consistent PDCP SN allocation. In this scenario, from the network perspective, a new N3 GTP-U tunnel needs to be established to deliver the data flow of the multicast/broadcast service from UPF to the target node. Meanwhile, the previous N3 GTP-U tunnel between source cell and UPF may be kept if there are other UEs in that cell receiving that multicast/broadcast service. This means the source side will continue to receive the data flow for that multicast/broadcast service from UPF after data forwarding. Same as multicast-multicast handover, a counter or timer-based approach may be used to control the amount of packets, which are subject to data forwarding.

For handover unicast-to-multicast handover 730, the transmission for the NR multicast/broadcast service is already available in the target cell. The existing transmission in target node can be in multicast manner serving a large number of UEs. The existing transmission in target node can be also in unicast manner serving a limit number of UEs but the addition of the switched UE triggers the target to transit the unicast transmission for NR multicast/broadcast service to p-t-m radio bearer-based transmission. During unicast→multicast switch, the unicast RB is available at source node for the UE to support reliable multicast/broadcast transmission. Then the same PDCP packets-based data forwarding is performed as the case of multicast-multicast handover. The only difference is that the sender of the PDCP packets is the PDCP entity of unicast radio bearer. If the source node needs to keep the data path from UPF e.g., to support the multicast transmission for other UEs, a counter may be used to control the number of packets which are subject to data forwarding. Alternatively, a timer can be used to serve the same purpose.

For unicast-to-unicast handover procedure 740, UE receives the multicast data via unicast manner in both source node and target node. The same PDCP packets-based data forwarding is performed as the case of multicast-to-multicast handover. These packets should be transmitted to the UE ahead of any new data coming from the PDCP entity established common to the multicast flow. If the source node needs to keep the data path from UPF, e.g., to support the multicast transmission for other UEs, a counter or timer-based approach may be used to control the number of packets which are subject to data forwarding. In one embodiment, the multicast transmission is actually already available in the target cell in unicast manner e.g., only serving another UE. The handover UE joining the multicast reception in the target node does not enable the p-t-m transmission. In this case, there is no multicast path switch over N3 interface.

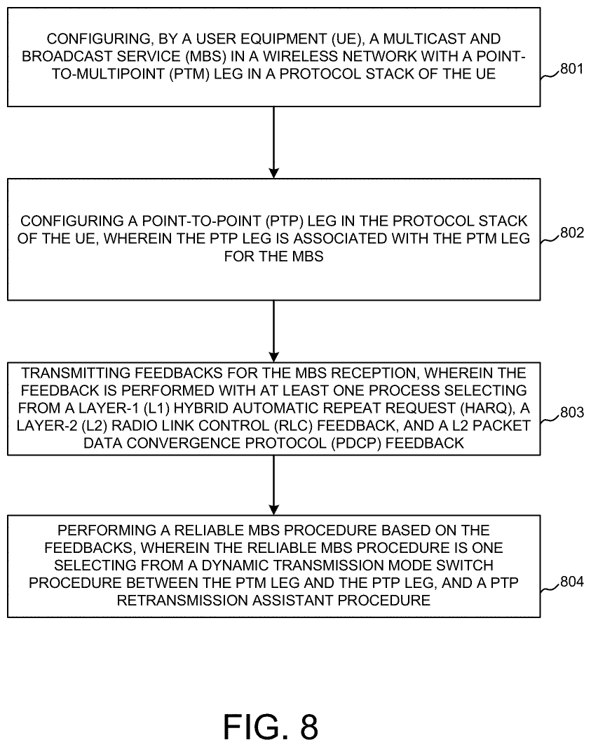

FIG. 8 illustrates an exemplary flow chart for the reliable MBS procedure in accordance with embodiments of the current invention. At step 801, the UE configures a multicast and broadcast service (MBS) in a wireless network with a point-to-multipoint (PTM) leg in a protocol stack of the UE. At step 802, the UE configures a point-to-point (PTP) leg in the protocol stack of the UE, wherein the PTP leg is associated with the PTM leg for the MBS. At step 803, the UE transmits feedbacks for the MBS reception, wherein the feedback is performed with at least one process selecting from a layer-1 (L1) hybrid automatic repeat request (HARQ), a layer-2 (L2) radio link control (RLC) feedback, and a L2 packet data convergence protocol (PDCP) feedback. At step 804, the UE performs a reliable MBS procedure based on the feedbacks, wherein the reliable MBS procedure is one selecting from a dynamic transmission mode switch procedure between the PTM leg and the PTP leg, and a PTP retransmission assistant procedure.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
configuring, by a user equipment (UE), a multicast and broadcast service (MBS) in a wireless network with a point-to-multipoint (PTM) leg in a protocol stack of the UE;
configuring a point-to-point (PTP) leg in the protocol stack of the UE, wherein the PTP leg is associated with the PTM leg for the MBS;
transmitting feedbacks for the MBS reception, wherein the feedback is performed with at least one process selecting from a layer-1 (L1) hybrid automatic repeat request (HARQ), a layer-2 (L2) radio link control (RLC) feedback, and a L2 packet data convergence protocol (PDCP) feedback; and
performing a reliable MBS procedure based on the feedbacks, wherein the reliable MBS procedure is one selecting from a dynamic transmission mode switch procedure between the PTM leg and the PTP leg, and a PTP retransmission assistant procedure.

2. The method of claim 1, wherein the PTM leg and the PTP leg are configured with a common PDCP entity and two different RLC entities including a PTM RLC entity for the PTM leg and a PTP RLC entity for the PTP leg.

3. The method of claim 2, wherein the UE performs dynamic switch from multicast radio bearer (RB) with the PTM leg to a unicast RB with the PTP leg for the MBS.

4. The method of claim 3, wherein the dynamic switch is triggered by the L1 HARQ only, and wherein the PTM RLC and the PTP RLC entities are unacknowledged mode (UM) RLC.

5. The method of claim 3, wherein the dynamic switch is triggered by the L1 HARQ only, and wherein the PTP RLC entity is an acknowledge mode (AM) RLC entity, and wherein PDCP packets with unacknowledged RLC packets or RLC segments are retransmitted through the PTP leg.

6. The method of claim 3, wherein the dynamic switch is triggered by UE L2 status reports, and wherein the UE is configured with L2 bidirectional feedback channel.

7. The method of claim 3, wherein the dynamic switch procedure is anchored by the common PDCP entity of the PTM leg and the PTP leg.

8. The method of claim 3, wherein entities of the PTM leg are released upon switching from the PTM leg to the PTP leg.

9. The method of claim 2, wherein the UE transmits feedbacks for the MBS received on the PTM leg through a unicast RB using the PTP leg and receives retransmission of MBS packets through the unicast RB using the PTP leg.

10. The method of claim 1, further comprising:
performing handover from a source node to a target node;
associating the PTP leg with a unicast RB of the target node; and
receiving unacknowledged PDCP packets through PTP leg, wherein the PDCP packets were transmitted from a PTP leg of the source node and was forwarded by the source node to the target node.

11. A user equipment (UE), comprising:
a transceiver that transmits and receives radio frequency (RF) signal in a new radio (NR) wireless network;
a multicast and broadcast service (MBS) configuration module that configures an MBS in the wireless network with a point-to-multipoint (PTM) leg in a protocol stack of the UE;
a point-to-point (PTP) module that configures PTP leg in the protocol stack of the UE, wherein the PTP leg is associated with the PTM leg for the MBS;
a feedback module that transmits feedbacks for the MBS reception, wherein the feedback is performed with at least one process selecting from a layer-1 (L1) hybrid automatic repeat request (HARQ), a layer-2 (L2) radio link control (RLC) feedback, and a L2 packet data convergence protocol (PDCP) feedback; and
an MBS control module that performs a reliable MBS procedure based on the feedbacks, wherein the reliable MBS procedure is one selecting from a dynamic transmission mode switch procedure between the PTM leg and the PTP leg, and a PTP retransmission assistant procedure.

12. The UE of claim 11, wherein the PTM leg and the PTP leg are configured with a common PDCP entity and two different RLC entities including a PTM RLC entity for the PTM leg and a PTP RLC entity for the PTP leg.

13. The UE of claim 12, wherein the UE performs dynamic switch from multicast radio bearer (RB) with the PTM leg to a unicast RB with the PTP leg for the MBS.

14. The UE of claim 13, wherein the dynamic switch is triggered by the L1 HARQ only, and wherein the PTM RLC and the PTP RLC entities are unacknowledged mode (UM) RLC.

15. The UE of claim 13, wherein the dynamic switch is triggered by the L1 HARQ only, and wherein the PTP RLC entity is an acknowledge mode (AM) RLC entity, and wherein PDCP packets with unacknowledged RLC packets or RLC segments are retransmitted through the PTP leg.

16. The UE of claim 13, wherein the dynamic switch is triggered by UE L2 status reports, and wherein the UE is configured with L2 bidirectional feedback channel.

17. The UE of claim 13, wherein the dynamic switch procedure is anchored by the common PDCP entity of the PTM leg and the PTP leg.

18. The UE of claim 13, wherein entities of the PTM leg are released upon switching from the PTM leg to the PTP leg.

19. The UE of claim 12, wherein the UE transmits feedbacks for the MBS received on the PTM leg through a unicast RB using the PTP leg and receives retransmission of MBS packets through the unicast RB using the PTP leg.

20. The UE of claim 11, further comprising a handover module that performs handover from a source node to a target node, associates the PTP leg with a unicast RB of the target node, and receives unacknowledged PDCP packets through PTP leg, wherein the PDCP packets were transmitted from a PTP leg of the source node and was forwarded by the source node to the target node.
